(19) United States
(12) Patent Application Publication
(10) Pub. No.: US 2026/0166372 A1
(43) Pub. Date: Jun. 18, 2026

(54) ULTRA-THIN OMNIDIRECTIONAL TREADMILL APPARATUS

(71) Applicant: All-Di WALK Corp., Gwangju (KR)

(72) Inventors: Jung Won Yoon, Gwangju (KR); Sang Hun Pyo, Gwangju (KR)

(73) Assignee: All-Di WALK Corp., Gwangju (KR)

(21) Appl. No.: 19/236,365

(22) Filed: Jun. 12, 2025

(30) Foreign Application Priority Data
Dec. 13, 2024 (KR) 10-2024-0186391

(51) Int. Cl. A63B 22/02

(52) U.S. Cl. CPC A63B 22/0235; A63B 22/0285; A63B 2022/0271

(57) ABSTRACT

An ultra-thin omnidirectional treadmill apparatus is provided. An ultra-thin omnidirectional treadmill apparatus according to an example of the present disclosure includes: a plurality of segments arranged continuously along a first direction, each segment including a belt member that provides a support surface for a user on one surface and has gear teeth formed continuously along a longitudinal direction on the opposite surface; a first rotational drive unit configured to move the plurality of segments along the first direction; and a second rotational drive unit configured to rotate the belt member of each segment in a second direction perpendicular to the first direction. The second rotational drive unit includes: a second drive motor; a plurality of helical gears rotated by the second drive motor; a plurality of helical timing pulleys configured to connect the plurality of helical gears to the plurality of belt members; upper power pulleys connected to some of the helical gears; lower power pulleys connected to the upper power pulleys via timing belts; and a second motor coupling member connected to the lower power pulleys to transmit the driving force of the second drive motor.

### CROSS-REFERENCE TO RELATED APPLICATION

This application claims the benefit under 35 U.S.C. § 119(a) of Korean Patent Application No. 10-2024-0186391, filed on Dec. 13, 2024, the entire disclosure of which is incorporated herein by reference for all purposes.

### BACKGROUND

### 1. Field

The present disclosure relates to an ultra-thin omnidirectional treadmill apparatus.

### 2. Description of Related Art

In general, platforms that provide an omnidirectional locomotion interface can be broadly classified into passive platforms, in which a user directly pushes the platform, and active platforms, in which a drive mechanism is incorporated.

One example of a passive platform is a device developed by Virtual Sphere. This platform includes a large hollow spherical metallic structure mounted on rollers having two degrees of freedom. When a user performs locomotion movements inside the spherical metallic structure, the structure rotates passively. Although such a passive platform enables an omnidirectional locomotion interface, it does not allow for the application of a drive mechanism. Therefore, when the user attempts to make high-speed forward movements, the inertia of the structure interferes with the sense of immersion. In addition, due to the non-flat representation of the walking surface, the platform delivers an unnatural and inconsistent walking sensation.

Another example of a passive platform is the Omni pad applied to the Immersive Group Simulator (IGS). However, since the user's body simply performs a stepping motion on a sliding pad while in a driven state, it cannot provide a sensation equivalent to actual walking.

Korean Patent No. 10-1670718 discloses an omnidirectional treadmill apparatus. In this registered patent, an Omni-pulley is used to drive the treadmill apparatus in all directions.

However, in the treadmill apparatus disclosed in Korean Patent No. 10-1670718, the Omni-pulley used therein includes a plurality of interference rollers that are spaced apart and rotate in engagement with a belt portion. As a result of this spacing, the interference rollers do not continuously engage with the belt portion, which leads to noise being generated each time the rollers engage with the belt. Furthermore, because the interference rollers do not continuously engage with the belt portion, there is a reduction in transmission force, thereby limiting the ability to increase the speed of the treadmill apparatus. In addition, since gear teeth are formed on the surface of the belt portion that supports the user, lubrication becomes difficult. If lubrication is applied, the user walking on the belt portion may slip and fall, resulting in potential safety accidents. Consequently, it is difficult to perform lubrication, and the friction between the belt and the Omni-pulley causes wear, ultimately leading to a shortened lifespan of the device.

In order to address the above-described problems, Korean Patent No. 10-2525750 discloses an improved omnidirectional treadmill apparatus. In the disclosed patent, a helical worm screw gear is applied, and gear teeth are formed on a belt member so as to enable uninterrupted and continuous engagement between the gear and the belt member.

However, in the treadmill apparatus disclosed in Korean Patent No. 10-2525750, the length of the helical worm screw gear becomes excessive relative to its diameter, requiring a disproportionately long gear. In addition, the helical-shaped machining consumes a considerable amount of time and cost. Furthermore, in order to prevent deflection of the helical worm screw gear, additional structural components are required, which increases the overall thickness of the treadmill apparatus, thereby making it difficult to realize an ultra-thin treadmill apparatus.

### SUMMARY

The present disclosure is directed to solving the above-described problems and provides an ultra-thin omnidirectional treadmill apparatus that can achieve a thickness comparable to that of a conventional treadmill while maintaining the user's locomotion performance. To ensure stable operation of the segments that support user movement, a sufficient number of gear teeth are engaged using small-diameter helical timing pulleys and helical gears. Moreover, even in cases where the segment width decreases due to the inclined configuration of the helical timing pulleys, stable engagement is reliably maintained.

It should be understood that the problems addressed by the present disclosure are not limited to those described above, and other problems not specifically mentioned will be readily understood by those skilled in the art based on the following description.

In one general aspect, an ultra-thin omnidirectional treadmill apparatus includes: a plurality of segments arranged continuously along a first direction, the segments including a plurality of belt members that respectively provide support surfaces for a user on one surface and have gear teeth formed continuously along a longitudinal direction on an opposite surface; a first rotational drive unit configured to move the plurality of segments along the first direction; and a second rotational drive unit configured to rotate the belt members of the respective segments in a second direction perpendicular to the first direction. The second rotational drive unit includes: a second drive motor; a plurality of helical gears rotated by the second drive motor; a plurality of helical timing pulleys configured to connect the plurality of helical gears and the plurality of belt members; upper power pulleys connected to some of the plurality of helical gears; lower power pulleys connected to the upper power pulleys via timing belts; and a second motor coupling member connected to the lower power pulleys and configured to transmit driving force of the second drive motor.

The upper power pulleys may be connected to only two helical gears among the plurality of helical gears.

The plurality of helical gears may include: a helical gear on one side connected via a timing belt to one of the two helical gears; and a helical gear on an opposite side connected via a timing belt to a different one of the two helical gears.

The two helical gears may be configured to respectively rotate three helical timing pulleys by the driving force of the second drive motor.

As each of the three helical timing pulleys rotates, helical gears connected to the rotating helical timing pulley are sequentially driven.

The belt member may include gear teeth formed parallel to the first direction.

The helical gear may be disposed such that a longitudinal axis of the helical gear is perpendicular to the first direction.

The helical timing pulley may be disposed such that a longitudinal axis of the helical timing pulley is inclined at a predetermined angle with respect to the first direction.

The ultra-thin omnidirectional treadmill apparatus may further include a plurality of HTP fixing members configured to respectively mount and secure the plurality of helical timing pulleys to a frame.

Other specific features of the present disclosure are included in the detailed description and the accompanying drawings.

According to the present disclosure, it is possible to implement an ultra-thin treadmill apparatus that allows a user to walk in all directions, including horizontal, vertical, and diagonal directions.

### BRIEF DESCRIPTION OF THE DRAWINGS

FIG. 1 is a diagram illustrating an ultra-thin omnidirectional treadmill apparatus according to an example of the present disclosure.

FIG. 2 is a diagram illustrating a portion of the ultra-thin omnidirectional treadmill apparatus according to an example of the present disclosure, excluding a frame.

FIG. 3 is a bottom view of a second rotational drive unit of the ultra-thin omnidirectional treadmill apparatus according to an example of the present disclosure.

FIG. 4 is a side view of the second rotational drive unit of the ultra-thin omnidirectional treadmill apparatus according to an example of the present disclosure.

FIG. 5 is a partially enlarged view of the second rotational drive unit of the ultra-thin omnidirectional treadmill apparatus according to an example of the present disclosure.

FIGS. 6 to 8 are diagrams illustrating helical gears and helical timing pulleys of the second rotational drive unit of the ultra-thin omnidirectional treadmill apparatus according to an example of the present disclosure.

FIG. 9 is a diagram illustrating a helical timing pulley (HTP) and an HTP fixing member that fixes the same in the ultra-thin omnidirectional treadmill apparatus according to an example of the present disclosure.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

A detailed description is given below, with reference to attached drawings.

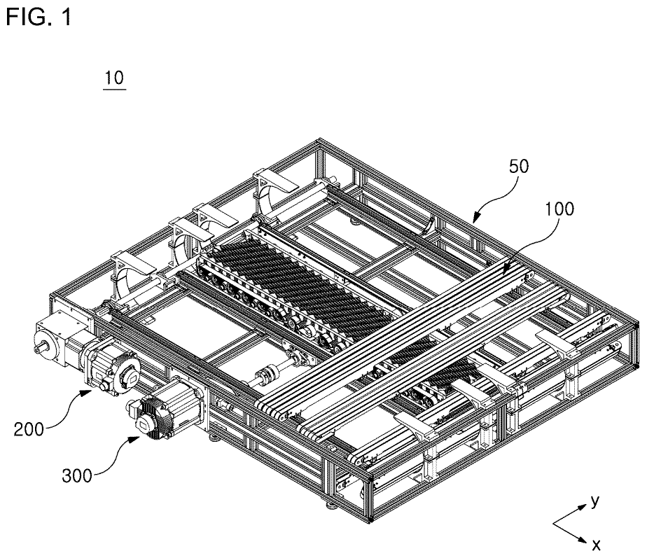

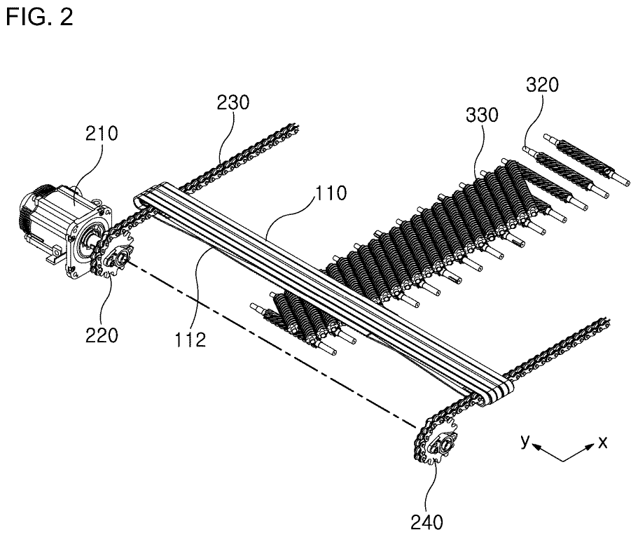

FIG. 1 is a diagram illustrating an ultra-thin omnidirectional treadmill apparatus according to an example of the present disclosure. FIG. 2 is a diagram illustrating a portion of the ultra-thin omnidirectional treadmill apparatus according to an example of the present disclosure, excluding a frame.

Referring to FIGS. 1 and 2, an ultra-thin omnidirectional treadmill apparatus 10 according to an example of the present disclosure includes segments 100, a first rotational drive unit 200, and a second rotational drive unit 300.

The segments 100, the first rotational drive unit 200, and the second rotational drive unit 300 are installed inside a frame 50, such that the frame 50 surrounds them, thereby providing protection from external impacts.

The segments 100 are arranged in plurality continuously along a first direction, and include a belt member 110 that provides a support surface for a user on one surface and has gear teeth 112 formed continuously along a longitudinal direction on the opposite surface. For convenience of explanation, the first direction is designated as the x-axis, and the second direction as the y-axis.

The belt member 110 provides a support surface for the user of the ultra-thin omnidirectional treadmill apparatus 10, and gear teeth 112 are formed on the surface opposite the support surface. Here, the gear teeth 112 of the belt member 110 may be formed parallel to the first direction.

The first rotational drive unit 200 moves the plurality of segments 100 along the first direction.

More specifically, the first rotational drive unit 200 may include a first drive motor 210, a pair of first rotation rollers 220 disposed to face each other along the first direction, a first rotation rail 230 on which each of the segments 100 is arranged in a continuous manner along the first direction and which forms a closed loop by surrounding the first rotation rollers 220, and a first motor coupling member 240 that connects the first drive motor 210 to at least one of the first rotation rollers 220.

Each segment 100 is longitudinally arranged on the first rotation rail 230 and continuously aligned along the first direction. As the first rotation rollers 220 are rotated by the driving force of the first drive motor 210, the first rotation rail 230 also rotates, and accordingly, each segment 100 is rotationally moved along the first direction in conjunction therewith.

In this case, the first drive motor 210 and the first motor coupling member 240 may be omitted. If the first drive motor 210 is omitted and no driving force is supplied from the outside, the segments 100 may be rotationally moved along the first direction by the force exerted when the user walks or runs on the segments 100.

The second rotational drive unit 300 rotates the belt members 110 of the respective segments 100 in a second direction perpendicular to the first direction. The second rotational drive unit 300 is disposed beneath the plurality of segments 100 and rotates the belt members 110 in the second direction.

In addition, the second rotational drive unit 300, together with the first rotational drive unit 200, rotationally moves the plurality of segments 100 in the first direction.

Hereinafter, the detailed configuration of the second rotational drive unit 300 will be described.

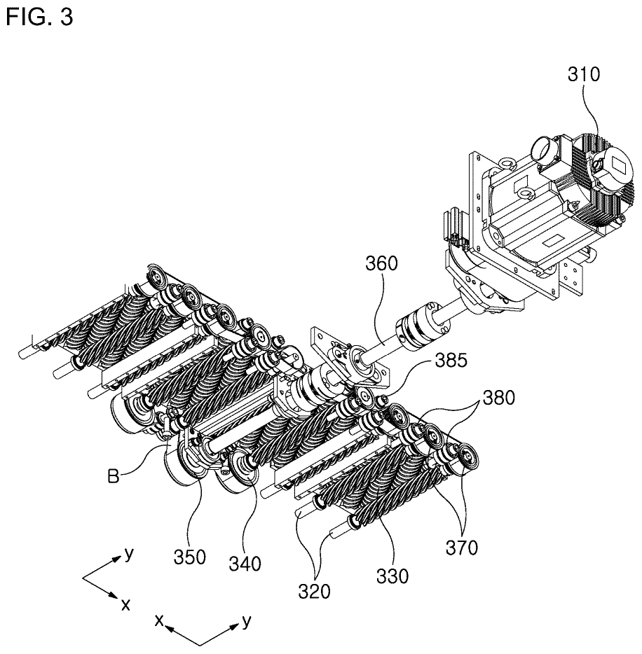

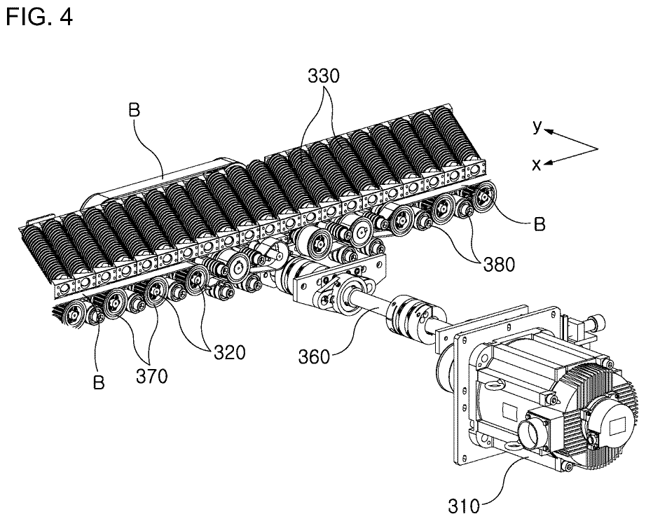

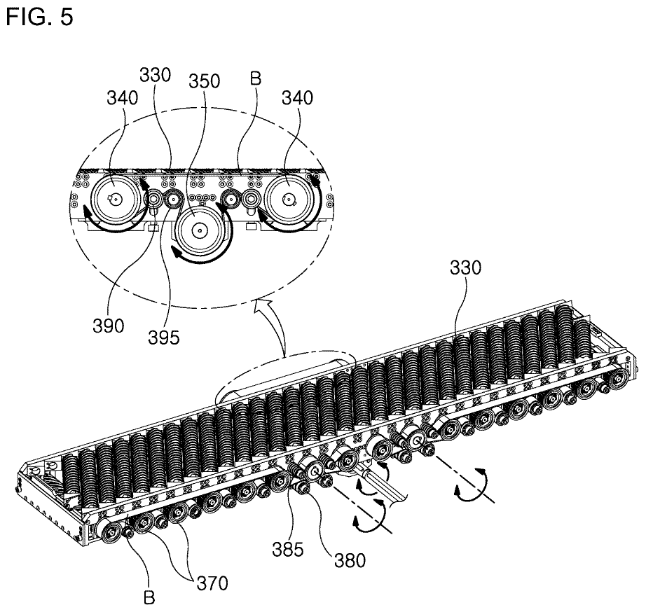

FIG. 3 is a bottom view of a second rotational drive unit of the ultra-thin omnidirectional treadmill apparatus according to an example of the present disclosure. FIG. 4 is a side view of the second rotational drive unit of the ultra-thin omnidirectional treadmill apparatus according to an example of the present disclosure. FIG. 5 is a partially enlarged view of the second rotational drive unit of the ultra-thin omnidirectional treadmill apparatus according to an example of the present disclosure.

Referring to FIGS. 3 to 5, the second rotational drive unit 300 may include a second drive motor 310, a plurality of helical gears 320 rotated by the second drive motor 310, a plurality of helical timing pulleys 330 configured to connect the plurality of helical gears 320 to a plurality of belt members 110, upper power pulleys 340 connected to a portion of the helical gears 320, lower power pulleys 350 connected to the upper power pulleys 340 via timing belts B, and a second motor coupling member 360 connected to the lower power pulleys 350 to transmit the driving force of the second drive motor 310.

Each helical gear 320 is positioned below the corresponding belt member 110 and may be arranged such that its longitudinal direction is parallel to that of the belt member 110. The helical gear 320 is engaged with a helical timing pulley 330 so as to rotate in conjunction therewith. That is, the helical gear 320 may be disposed perpendicular to the first direction.

Each helical timing pulley 330 is positioned below the belt member 110 and above the helical gear 320, and serves to connect the helical gear 320 to the belt member 110. The helical timing pulley 330, located between the helical gear 320 and the belt member 110, is inclined at a predetermined angle with respect to the helical gear 320 and the belt member 110, both of which are arranged parallel to each other in their longitudinal directions. In other words, the longitudinal direction of the helical timing pulley 330 may be inclined at a predetermined angle relative to the first direction.

Accordingly, a plurality of helical timing pulleys 330 may be engaged with a single helical gear 320, and a plurality of belt members 110 may be engaged with a single helical timing pulley 330. With such a meshing structure, even if one helical gear 320 rotates, all the helical gears 320 and the helical timing pulleys 330 can be rotated. As a result, the belt members 110 can be rotated in the second direction and moved in the first direction.

In addition, since driving force can be transmitted even when a helical gear 320 having a relatively short length is used, the length of the helical gear 320 can be configured to be shorter relative to the length of the belt member 110.

When the driving force of the second drive motor 310 is transmitted to the helical gear 320, the helical gear 320 rotates, thereby rotating the engaged helical timing pulley 330. Accordingly, since the helical gears 320 and the helical timing pulleys 330 are independently connected in a many-to-many configuration, it is sufficient for the driving force to be transmitted to only some of the helical gears 320.

Driving force is transmitted from the second drive motor 310 to the helical gear 320 through the use of pulleys and coupling members.

Specifically, the second motor coupling member 360 is directly connected to the second drive motor 310. The lower power pulley 350 is directly connected to the second motor coupling member 360, and the upper power pulley 340 is connected to some of the helical gears 320. The upper power pulley 340 and the lower power pulley 350 are connected to each other via the timing belts B.

Referring again to FIG. 5, two upper power pulleys 340 are respectively connected to two of the helical gears 320 among the plurality of helical gears 320.

A pair of upper power pulleys 340 is connected to a single lower power pulley 350 via the timing belts B.

A first auxiliary roller 390 and a second auxiliary roller 395 may be positioned between the upper power pulley 340 and the lower power pulley 350.

The first auxiliary roller 390 and the second auxiliary roller 395 support the timing belts B, which connects the pair of upper power pulleys 340 to the single lower power pulley 350, and adjust the tension of the timing belts B.

The lower power pulley 350 is directly connected to the second motor coupling member 360 and receives the driving force from the second drive motor 310. The second motor coupling member 360 passes beneath the helical gear 320 to transmit the driving force of the second drive motor 310 to the lower power pulley 350.

As the second drive motor 310 operates, the lower power pulley 350 rotates, thereby rotating the upper power pulleys 340. The upper power pulleys 340 and the lower power pulley 350 rotate in the same direction.

Accordingly, when the second drive motor 310 operates, the helical gears 320 connected to the upper power pulleys 340 are rotated.

To transmit the driving force of the second drive motor 310 to all the helical gears 320, additional helical gears 320 are connected to those helical gears 320 that are coupled to the upper power pulleys 340.

As shown in FIG. 5, among the two helical gears 320 connected to the upper power pulleys 340, one helical gear may be connected to a helical gear on one side via the timing belts B, and the other helical gear may be connected to a helical gear on the opposite side via the timing belts B. That is, the helical gears 320 may be divided into two groups, with each group being connected via the timing belts B.

In addition, a first support roller 380 and a second support roller 385 may be positioned between adjacent helical gears 320. The first support roller 380 may support the lower side of the timing belts B, and the second support roller 385 may support the upper side of the timing belts B.

Hereinafter, the specific operation of the second rotational drive unit of the ultra-thin omnidirectional treadmill apparatus according to an example of the present disclosure will be described in detail.

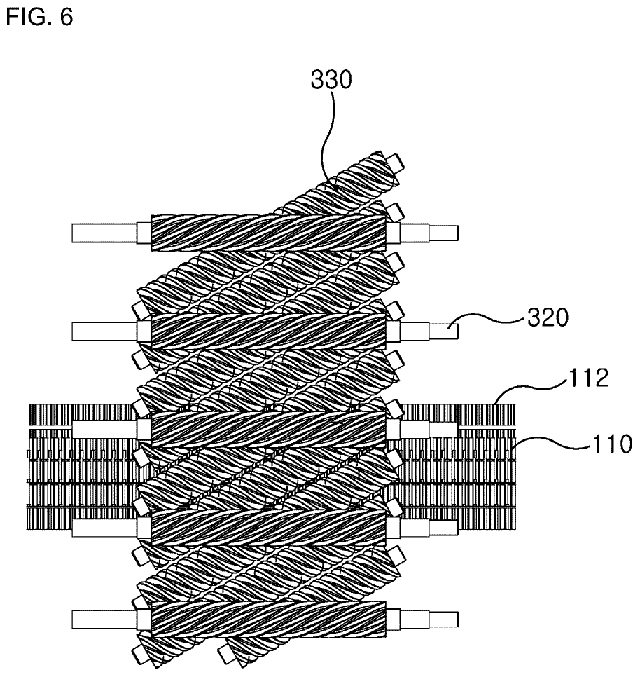

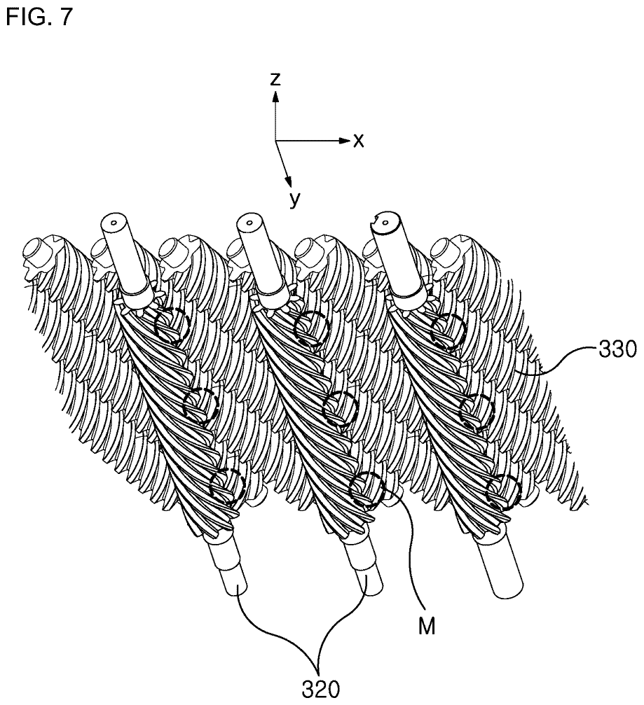

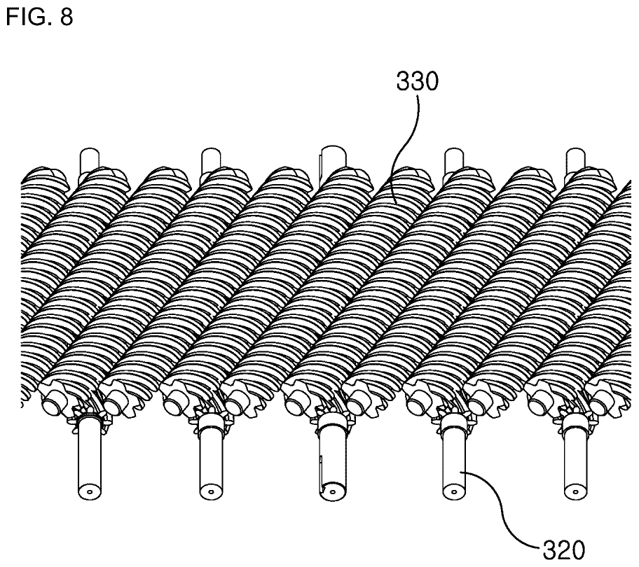

FIGS. 6 to 8 are diagrams illustrating helical gears and helical timing pulleys of the second rotational drive unit of the ultra-thin omnidirectional treadmill apparatus according to an example of the present disclosure.

Referring to FIGS. 6 to 8, three helical timing pulleys 330 are connected to each helical gear 320.

When the upper power pulley 340 is driven by the driving force of the second drive motor 310, the helical gear 320 connected to the upper power pulley 340 rotates, and the three helical timing pulleys 330 connected to the helical gear 320 also rotate.

Further, other helical gears 320 connected to the helical gear 320 coupled to the upper power pulley 340 via the timing belts B are also rotated. Additionally, the three helical timing pulleys 330 connected to the helical gear 320 coupled to the upper power pulley 340 rotate, and accordingly, other helical gears 320 connected to the rotating helical timing pulleys 330 are sequentially driven.

That is, as the two helical gears 320 coupled to the upper power pulleys 340 rotate, they rotate the three helical timing pulleys 330 and simultaneously drive the two divided timing belts B to rotate the helical gears 320.

Through chained meshing between the helical gears 320 and the helical timing pulleys 330, the rotation of the three helical timing pulleys 330 driven by the helical gears 320 that directly receive the driving force from the second drive motor 310 sequentially drives other helical gears 320. At the same time, the helical gears 320 are also directly rotated via the timing belts B to drive the remaining helical timing pulleys 330.

As a result, misalignment of a collinear line due to backlash between the helical gears 320 and the helical timing pulleys 330 can be prevented, so that no resistance occurs when the segments 110 move in the first direction. In addition, uniform driving force can be transmitted to the helical gears 320, and a large number of connection points between the helical gears 320 and the helical timing pulleys 330 can be implemented, thereby ensuring high rigidity.

Accordingly, the thickness of the ultra-thin omnidirectional treadmill apparatus 10 can be reduced, enabling ultra-thin implementation.

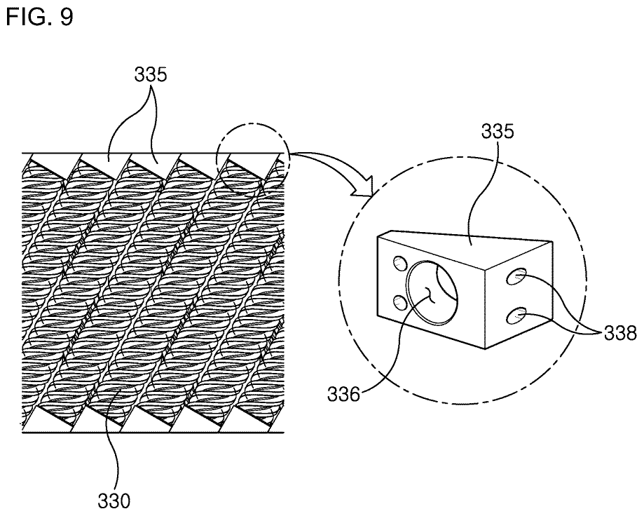

FIG. 9 is a diagram illustrating a helical timing pulley (HTP) and an HTP fixing member that fixes the same in the ultra-thin omnidirectional treadmill apparatus according to an example of the present disclosure.

Referring to FIG. 9, a HTP fixing member 335 secures a helical timing pulley 330 to a frame 50.

The HTP fixing member 335 may include a coupling hole 336 into which the helical timing pulley 330 is inserted and engaged, and a plurality of fastening holes 338 for screw fastening.

Since the helical timing pulley 330 is inclined with respect to a helical gear 320 and a belt member 110, it is installed at an inclined angle relative to the rectangular frame 50. In consideration of this, the HTP fixing member 335 may be designed such that one surface of the HTP fixing member 335 is formed at an inclined angle corresponding to the inclined angle between the helical timing pulley 330 and the frame 50.

As shown in FIG. 9, when the helical timing pulley 330 is coupled to the frame 50 using the HTP fixing member 335, proper alignment of the helical timing pulleys 330 is automatically secured through contact between adjacent helical timing pulleys 330, thereby reducing assembly tolerances.

As described above, in the ultra-thin omnidirectional treadmill apparatus 10, small-diameter helical timing pulleys 330 and helical gears 320 can engage with a sufficient number of teeth to ensure stable operation of the segments 100, which include the belt members 110. In addition, even when the width of the segment 100 is reduced due to the helical timing pulleys 330 being inclined with respect to the helical gears 320 and the belt members 110, stable tooth engagement can still be ensured. Therefore, the treadmill can be implemented in an ultra-thin omnidirectional form.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An ultra-thin omnidirectional treadmill apparatus comprising:
a plurality of segments arranged continuously along a first direction, the segments including a plurality of belt members that respectively provide support surfaces for a user on one surface and have gear teeth formed continuously along a longitudinal direction on an opposite surface;
a first rotational drive unit configured to move the plurality of segments along the first direction; and
a second rotational drive unit configured to rotate the belt members of the respective segments in a second direction perpendicular to the first direction,
wherein the second rotational drive unit comprises:
a second drive motor;
a plurality of helical gears rotated by the second drive motor;
a plurality of helical timing pulleys configured to connect the plurality of helical gears and the plurality of belt members;
upper power pulleys connected to some of the plurality of helical gears;
lower power pulleys connected to the upper power pulleys via timing belts; and
a second motor coupling member connected to the lower power pulleys and configured to transmit driving force of the second drive motor.

2. The ultra-thin omnidirectional treadmill apparatus of claim 1,
wherein the upper power pulleys are connected to only two helical gears among the plurality of helical gears.

3. The ultra-thin omnidirectional treadmill apparatus of claim 2,
wherein the plurality of helical gears comprises:
a helical gear on one side connected via a timing belt to one of the two helical gears; and
a helical gear on an opposite side connected via a timing belt to a different one of the two helical gears.

4. The ultra-thin omnidirectional treadmill apparatus of claim 2,
wherein the two helical gears are configured to respectively rotate three helical timing pulleys by the driving force of the second drive motor.

5. The ultra-thin omnidirectional treadmill apparatus of claim 4,
wherein, as each of the three helical timing pulleys rotates, helical gears connected to the rotating helical timing pulley are sequentially driven.

6. The ultra-thin omnidirectional treadmill apparatus of claim 1,
wherein the belt member comprises gear teeth formed parallel to the first direction.

7. The ultra-thin omnidirectional treadmill apparatus of claim 6,
wherein the helical gear is disposed such that a longitudinal axis of the helical gear is perpendicular to the first direction.

8. The ultra-thin omnidirectional treadmill apparatus of claim 6,
wherein the helical timing pulley is disposed such that a longitudinal axis of the helical timing pulley is inclined at a predetermined angle with respect to the first direction.

9. The ultra-thin omnidirectional treadmill apparatus of claim 8, further comprising:
a plurality of HTP fixing members configured to respectively mount and secure the plurality of helical timing pulleys to a frame.
